(19) United States
(12) Patent Application Publication
(10) Pub. No.: US 2016/0111221 A1
(43) Pub. Date: Apr. 21, 2016

(54) SOLID ELECTROLYTIC CAPACITOR

(71) Applicant: NEC Tokin Corporation, Sendai-shi (JP)

(72) Inventors: Yuji Murayama, Sendai-shi (JP); Koji Sakata, Sendai-shi (JP); Yasuhisa Sugawara, Sendai-shi (JP); Hiroki Sato, Sendai-shi (JP)

(21) Appl. No.: 14/731,310

(22) Filed: Jun. 4, 2015

(30) Foreign Application Priority Data
Oct. 20, 2014 (JP) 2014-213617

(51) Int. Cl. H01G 9/042; H01G 9/15; H01G 9/032

(52) U.S. Cl. CPC H01G 9/042; H01G 9/032; H01G 9/15

(57) ABSTRACT

A solid electrolytic capacitor including an alloy composed of titanium and zirconium as an anode conductor, an oxide film obtained by anodizing the anode conductor as a dielectric layer, and a conductive polymer as an electrolyte, wherein an atomic ratio of titanium and zirconium in the alloy of the anode conductor is from 80:20 to 10:90 as Ti:Zr, and wherein a film thickness of the oxide film is 5 nm or more and 1000 nm or less.

### BACKGROUND OF THE INVENTION

1. Field of the Invention

The present invention relates to a solid electrolytic capacitor in which an alloy of Ti and Zr is employed for the anode, a dielectric layer composed of an oxide is formed by anodization, and a conductive polymer is employed as the electrolyte.

2. Related Art

In a conventional solid electrolytic capacitor, a valve metal has been employed for an anode and an oxide of the valve metal has been formed on the surface of the anode as a dielectric layer by an electrolytic oxidation method or the like. As the valve metals, there have been known aluminum, tantalum, niobium, titanium, zirconium and the like. In particular, capacity of capacitors has been required to be further enhanced in recent years, and therefore titanium, of which oxide film has a high dielectric constant, has been investigated to be used.

However, an electrolytic capacitor manufactured through electrolytic oxidation of titanium has the problem of causing larger leakage current compared to the conventionally commercialized electrolytic capacitors employing aluminum, tantalum or the like.

In order to prevent deterioration of the leakage current characteristics, WO2007/020969 (D1) proposes to improve the electrolytic oxidation conditions, i.e., the method for chemical conversion treatment of the anode. There is also proposed use of alloys of valve metals for the anode. JPH07-268688A (D2) proposes to improve the composition of the anodizing solution used in the anodization, JP2004-146805A (D3) proposes to anodize an anode composed of a nitrogen-doped titanium or a nitrogen-doped titanium alloy, and JP2004-349658A (D4) proposes to perform fluorine-doping during the anodization.

WO2011/145372 (D5) discloses a method for suppressing a crystalline oxide film from being formed by vapor-depositing titanium or a titanium alloy on a substrate and further forming a protective film of zinc, followed by dissolving the zinc protective film in the anodizing solution to anodize the titanium or titanium alloy film in order to prevent a natural oxide film from being formed prior to anodization of titanium or a titanium alloy.

On the other hand, there have been known solid electrolytic capacitors, in which a solid electrolyte is employed in place of the conventional liquid electrolyte. Conductive polymers have been proposed to be employed as the solid electrolyte.

Although D1 and D2 suggest alloys, D1 and D2 provide neither specific composition ratios of the alloys nor examples using the alloys and just provide examples with aluminum foil or pure titanium foil. Although both of D3 and D4 describe also electrolytic capacitors in which the dielectric is formed by anodizing a titanium alloy, the amounts of the added metals are 5% by weight or less or 10% by weight or less. In addition, although D1 to D4 suggest also use of solid electrolytes such as conductive polymers, examples thereof are limited to evaluation up to the anodization.

D5 provides an example of a TiZr alloy of Ti:77 atomic %-Zr:23 atomic % in Experimental Example 3 as a Ti alloy anode. Although a leakage current density is evaluated, evaluation is performed just using a liquid electrolyte. In addition, the anodizing time is set to be 10 minutes at 15 V, and therefore the oxide film to be formed is speculated to be extremely thin.

### SUMMARY OF THE INVENTION

As described above, there have not conventionally been provided examples investigating combinations of alloys of valve metals and electrolytes containing a conductive polymer. The present inventors have found that when an anode conductor composed of an alloy of valve metals, in particular an alloy of titanium and zirconium, is anodized to form an oxide film and an electrolyte layer containing a conductive polymer is formed as the solid electrolyte, the capacitance or the leakage current widely varies depending on the compositions of the alloy or the thickness of the oxide film. Accordingly, it is an object of the present invention to attain both good capacitance and excellent leakage current characteristics in a solid electrolytic capacitor in combination of an anode conductor composed of an alloy of valve metals, a dielectric composed of an oxide film obtained by anodizing the anode conductor, and an electrolyte containing a conductive polymer.

That is, the present invention relates to a solid electrolytic capacitor including an alloy composed of titanium and zirconium as an anode conductor, an oxide film obtained by anodizing the anode conductor as a dielectric layer, and a conductive polymer as an electrolyte, wherein an atomic ratio of titanium and zirconium in the alloy of the anode conductor is from 80:20 to 10:90 as Ti:Zr, and wherein a film thickness of the oxide film is 5 nm or more and 1000 nm or less.

According to the present invention, there can be attained both good capacitance and excellent leakage current characteristics in a solid electrolytic capacitor in which a dielectric layer is formed by chemical conversion treatment of an anode conductor composed of an alloy of titanium and zirconium and a conductive polymer is included as the electrolyte.

### BRIEF DESCRIPTION OF THE DRAWINGS

FIG. 1 is a schematic cross section of a solid electrolytic capacitor according to an embodiment of the present invention.

### DETAILED DESCRIPTION OF THE PREFERRED EMBODIMENTS

Hereinafter, the present invention will be described providing an embodiment thereof, but the present invention is not limited to this embodiment only.

### Embodiment 1

When an alloy composed of titanium (Ti) and zirconium (Zr) is employed for the anode conductor and the anode conductor is anodized in an electrolytic solution, an oxide film, which is a dielectric layer, is formed on the anode surface. An electrolyte layer containing a conductive polymer is formed on the oxide film.

In the present invention, it has been found when titanium, of which oxide film is excellent in a relative dielectric constant, is selected from among the valve metals, titanium is alloyed with zirconium, which is a homologue of titanium, and the alloy is combined with an electrolyte containing a conductive polymer, there can be attained both good capacitance and excellent leakage current characteristics under prescribed conditions.

Since Ti and Zr are homologous elements and form a complete solid solution, a homogeneous alloy can be advantageously obtained in any composition, and when Zr is contained in an atomic proportion of 20% or more, the leakage current is lowered after formation of the electrolyte layer containing a conductive polymer, thereby making the capacitor characteristics better. In addition, when the atomic proportion of Zr is 90% or less, the capacitance indicates a better value than that of the solid electrolytic capacitor employing Ta for the anode conductor. Furthermore, the atomic proportion of Zr is more preferably 20% or more and 70% or less because the dielectric layer has an amorphous structure, thereby improving the heat resistance characteristics of the capacitor. That is, the anode conductor according to the present invention is an alloy having an atomic ratio of titanium and zirconium from 80:20 to 10:90 as Ti:Zr, and the atomic ratio of Ti:Zr is preferably from 80:20 to 30:70.

Regarding the alloy constituting the anode conductor composed of Ti and Zr, there may be utilized that produced by an arc melting method, a sintering method, a spattering method, a mechanical alloying method or the like. The shape of the anode conductor may be any known shapes such as plate, foil and wire. In addition, the anode conductor may be that constituted of a suitable substrate and an alloy film composed of Ti and Zr formed on the substrate. The anode conductor formed by a sintering method has fine vacancies to make surface area thereof larger, thereby being advantageous for solid electrolytic capacitors to which high capacitance is required.

When the dielectric layer composed of an oxide film formed by anodization has a film thickness of 5 nm or more and 1000 nm or less, the leakage current is lowered after formation of the electrolyte layer containing a conductive polymer. The film thickness of the oxide film is determined depending on the processing voltage during the anodization and the anode composition, and when the atomic proportion of Zr is 20% or more, the anodizing voltage of 3 V or more and 500 V or less may lead to a film thickness of 5 nm or more and 1000 nm or less by the processing for several hours. The smaller the film thickness of the dielectric layer is, the higher the capacitance becomes, and the larger the film thickness is, the higher voltage the capacitor can be used at. Accordingly, the film thickness may be suitably selected from the range described above depending on the performance required for the solid electrolytic capacitor.

In the anodization, a known electrolytic solution may be used. There may be used an aqueous or non-aqueous solution containing phosphoric acid, nitric acid, boric acid, citric acid or sodium salts or ammonium salts thereof.

For the conductive polymer contained in the electrolyte layer formed on the dielectric layer composed of an oxide film, there may be used one or more selected from polypyrrole, polythiophene, polyaniline, polysilane or derivatives thereof. As the method for forming the electrolyte layer containing the conductive polymer, there may be applied a chemical oxidation polymerization method, an electrolytic polymerization method or a method involving applying a dispersion or a solution and drying. The electrolyte layer may contain a dopant allowing the conductive polymer to exert electroconductivity and may further contain a binder as necessary. The dopant includes anionic dopants and polyacid anions are particularly preferred. The binder includes acrylic resins, urethane resins, epoxy resins, phenol resins, silicone resins, polyester resins, polyolefin resins and water-soluble resins such as polyvinyl alcohol and saccharides.

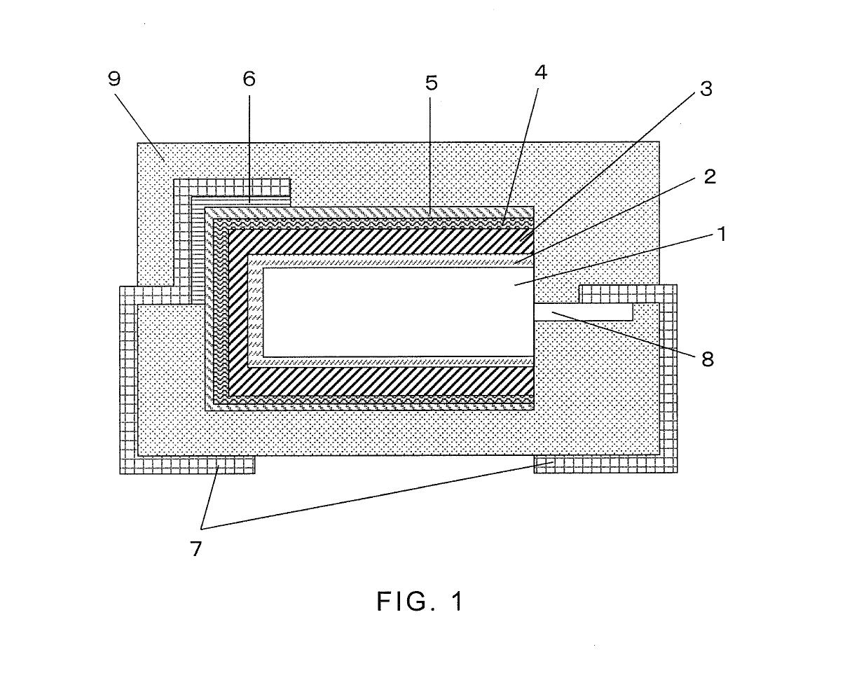

FIG. 1 is a schematic cross section illustrating a structure of a solid electrolytic capacitor according to the present embodiment. This solid electrolytic capacitor has a structure where dielectric layer 2 and electrolyte layer 3 are formed in this order on anode conductor 1. Graphite layer 4 and silver layer 5 are formed around electrolyte layer 3 to form a cathode, and the cathode is, via conductive glue 6, further connected to electrode 7 which is to be a connecting terminal with the outside. In addition, on the surface of anode conductor 1 on which electrolyte layer 3 is not formed, metal lead 8 made of a valve metal same as that used for anode conductor 1 is provided and metal lead 8 is connected to electrode 7, which is a connecting terminal, different from that to which the cathode is connected. In addition, all these components are covered with insulating exterior mold resin 9 such as an epoxy resin to form an electrolytic capacitor.

Hereinafter, the present invention will be specifically described providing examples, but the present invention is not limited to these examples only.

### EXAMPLE 1

Using an alloy plate having an atomic ratio of Ti and Zr of 80:20 manufactured by a button arc melting method as an anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 200 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### EXAMPLE 2

Using an alloy plate having an atomic ratio of Ti and Zr of 70:30 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 190 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### EXAMPLE 3

Using an alloy plate having an atomic ratio of Ti and Zr of 40:60 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 183 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### EXAMPLE 4

Using an alloy plate having an atomic ratio of Ti and Zr of 10:90 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 195 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### COMPARATIVE EXAMPLE 1

Using an alloy plate having an atomic ratio of Ti and Zr of 90:10 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 215 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### COMPARATIVE EXAMPLE 2

Using an alloy plate having an atomic ratio of Ti and Zr of 85:15 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 210 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### COMPARATIVE EXAMPLE 3

Using an alloy plate having an atomic ratio of Ti and Zr of 5:95 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 200 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

### COMPARATIVE EXAMPLE 4

Using an alloy plate having an atomic ratio of Ti and Zr of 0:100 manufactured by a button arc melting method as the anode, anodization was carried out at room temperature at 100 V for 2 hours with an electrolytic solution containing 0.05 wt % of phosphoric acid, 50 wt % of ethylene glycol and water. The film thickness of thus formed oxide film was determined to be 210 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 50 V.

There are shown in Table 1 the summarized results of capacitance and leakage current for Examples 1-4 and Comparative Examples 1-4.

TABLE 1

| | Ti:Zr | Anodizing | Oxide film | | Leakage |
|---|---|---|---|---|---|
| | atomic | voltage | thickness | Capacitance | current |
| | ratio | (V) | (nm) | (μF/cm²) | (μA/μFV) |
| Comparative | 90:10 | 100 | 215 | 0.20 | 0.25 |
| Example 1 | | | | | |
| Comparative | 85:15 | 100 | 210 | 0.18 | 0.15 |
| Example 2 | | | | | |
| Example 1 | 80:20 | 100 | 200 | 0.15 | 0.08 |
| Example 2 | 70:30 | 100 | 190 | 0.14 | 0.04 |
| Example 3 | 40:60 | 100 | 183 | 0.18 | 0.05 |
| Example 4 | 10:90 | 100 | 195 | 0.14 | 0.06 |
| Comparative | 5:95 | 100 | 200 | 0.12 | 0.06 |
| Example 3 | | | | | |
| Comparative | 0:100 | 100 | 210 | 0.11 | 0.07 |
| Example 4 | | | | | |

As seen in Table 1, the atomic proportions of Zr of 20% or more resulted in the leakage current less than 0.1 μA/μFV, which is a typical specification value for solid electrolytic capacitors employing a conductive polymer as an electrolyte. In addition, the atomic proportions of Zr of 90% or less led to good results of the capacitance of 0.14 ρF/cm² or more.

### EXAMPLE 5

Using an alloy plate having an atomic ratio of Ti and Zr of 70:30 manufactured by a button arc melting method as the anode, anodization was carried out at room temperature at 5 V for 2 hours with an electrolytic solution containing 0.05 wt % of phosphoric acid, 50 wt % of ethylene glycol and water. The film thickness of thus formed oxide film was determined to be 10 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 2.5 V.

### EXAMPLE 6

Using an alloy plate having an atomic ratio of Ti and Zr of 70:30 manufactured by a button arc melting method as the anode, anodization was carried out at room temperature at 300 V for 2 hours with an electrolytic solution containing 0.05 wt % of phosphoric acid, 50 wt % of ethylene glycol and water. The film thickness of thus formed oxide film was determined to be 570 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 150 V.

### EXAMPLE 7

Using an alloy plate having an atomic ratio of Ti and Zr of 70:30 manufactured by a button arc melting method as the anode, anodization was carried out at room temperature at 500 V for 2 hours with an electrolytic solution containing 0.05 wt % of phosphoric acid, 50 wt % of ethylene glycol and water. The film thickness of thus formed oxide film was determined to be 950 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 250 V.

### EXAMPLE 8

Using an alloy plate having an atomic ratio of Ti and Zr of 40:60 manufactured by a button arc melting method as the anode, anodization was carried out at room temperature at 5 V for 2 hours with an electrolytic solution containing 0.05 wt % of phosphoric acid, 50 wt % of ethylene glycol and water. The film thickness of thus formed oxide film was determined to be 9 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 2.5 V.

### EXAMPLE 9

Using an alloy plate having an atomic ratio of Ti and Zr of 40:60 manufactured by a button arc melting method as the anode, anodization was carried out at room temperature at 300 V for 2 hours with an electrolytic solution containing 0.05 wt % of phosphoric acid, 50 wt % of ethylene glycol and water. The film thickness of thus formed oxide film was determined to be 549 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 150 V.

### EXAMPLE 10

Using an alloy plate having an atomic ratio of Ti and Zr of 40:60 manufactured by a button arc melting method as the anode, anodization was carried out at room temperature at 500 V for 2 hours with an electrolytic solution containing 0.05 wt % of phosphoric acid, 50 wt % of ethylene glycol and water. The film thickness of thus formed oxide film was determined to be 915 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 250 V.

### COMPARATIVE EXAMPLE 5

Using an alloy plate having an atomic ratio of Ti and Zr of 70:30 manufactured by a button arc melting method as the anode, anodization was carried out at room temperature at 2 V for 2 hours with an electrolytic solution containing 0.05 wt % of phosphoric acid, 50 wt % of ethylene glycol and water.

The film thickness of thus formed oxide film was determined to be 4 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 1 V.

### COMPARATIVE EXAMPLE 6

Using an alloy plate having an atomic ratio of Ti and Zr of 70:30 manufactured by a button arc melting method as the anode, anodization was carried out at room temperature at 550 V for 2 hours with an electrolytic solution containing 0.05 wt % of phosphoric acid, 50 wt % of ethylene glycol and water. The film thickness of thus formed oxide film was determined to be 1045 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 275 V.

### COMPARATIVE EXAMPLE 7

Using an alloy plate having an atomic ratio of Ti and Zr of 40:60 manufactured by a button arc melting method as the anode, anodization was carried out at room temperature at 2 V for 2 hours with an electrolytic solution containing 0.05 wt % of phosphoric acid, 50 wt % of ethylene glycol and water. The film thickness of thus formed oxide film was determined to be 4 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 1 V.

### COMPARATIVE EXAMPLE 8

Using an alloy plate having an atomic ratio of Ti and Zr of 40:60 manufactured by a button arc melting method as the anode, anodization was carried out at room temperature at 550 V for 2 hours with an electrolytic solution containing 0.05 wt % of phosphoric acid, 50 wt % of ethylene glycol and water. The film thickness of thus formed oxide film was determined to be 1007 nm by a transmission electron microscope.

Then, a dispersion of polythiophene, which is a conductive polymer, was applied on the oxide film, and subsequently the applied film was dried to form an electrolyte layer. Further, graphite paste and silver paste were applied and cured, thereby forming a cathode lead-out layer to give a solid electrolytic capacitor.

For the resulting solid electrolytic capacitor, capacitance was determined at frequency of 120 Hz. Leakage current was also determined after 5 minutes of applying a direct current voltage of 275 V.

There are shown in Table 2 the summarized results of the capacitance and the leakage current for Examples 5-10 and Comparative Examples 5-8.

TABLE 2

| | Ti:Zr | Anodizing | Oxide film | | Leakage |
|---|---|---|---|---|---|
| | atomic | voltage | thickness | Capacitance | current |
| | ratio | (V) | (nm) | (μF/cm²) | (μA/μFV) |
| Comparative | 70:30 | 2 | 4 | 7 | 0.14 |
| Example 5 | | | | | |
| Example 5 | 70:30 | 5 | 10 | 2.8 | 0.06 |
| Example 2 | 70:30 | 100 | 190 | 0.14 | 0.04 |
| Example 6 | 70:30 | 300 | 570 | 0.047 | 0.04 |
| Example 7 | 70:30 | 500 | 950 | 0.028 | 0.07 |
| Comparative | 70:30 | 550 | 1045 | 0.025 | 0.30 |
| Example 6 | | | | | |
| Comparative | 40:60 | 2 | 4 | 9 | 0.15 |
| Example 7 | | | | | |
| Example 8 | 40:60 | 5 | 9 | 3.6 | 0.06 |
| Example 3 | 40:60 | 100 | 183 | 0.18 | 0.05 |
| Example 9 | 40:60 | 300 | 549 | 0.06 | 0.05 |
| Example 10 | 40:60 | 500 | 915 | 0.036 | 0.08 |
| Comparative | 40:60 | 550 | 1007 | 0.033 | 0.32 |
| Example 8 | | | | | |

As seen in Table 2, the film thicknesses of the oxide films of 5 nm or more and 1000 nm or less resulted in the leakage current less than 0.1 μA/μFV, which is a typical specification value for solid electrolytic capacitors employing a conductive polymer as an electrolyte.

What is claimed is:

1. A solid electrolytic capacitor comprising:
an alloy composed of titanium and zirconium as an anode conductor;
an oxide film obtained by anodizing the anode conductor as a dielectric layer; and
a conductive polymer as an electrolyte,
wherein an atomic ratio of titanium and zirconium in the alloy of the anode conductor is from 80:20 to 10:90 as Ti:Zr, and
wherein a film thickness of the oxide film is 5 nm or more and 1000 nm or less.

2. The solid electrolytic capacitor according to claim 1, wherein the film thickness of the oxide film obtained by anodizing the anode conductor is 9 nm or more and 950 nm or less.
